(19) United States
(12) Patent Application Publication
(10) Pub. No.: US 2006/0048362 A1
(43) Pub. Date: Mar. 9, 2006

(54) Arrowhead extractor

(76) Inventor: Everett Allen Gunnlaugsson, Joliet, IL (US)

Correspondence Address: Everett Gunnlaugsson, 1700 Valley Pkw. E., Joliet, IL, 60433, US

(21) Appl. No.: 10/811,384

(22) Filed: Sep. 3, 2004

(51) Int. Cl. B23P 19/04

(52) U.S. Cl. 29/256

(57) ABSTRACT

Archery products have become more popular than ever, and the cost of these products Has increased substantially, therefore trying to recover or retrieve some of these products Such as the arrowhead can save the consumer money. So I invented an Arrowhead Extractor in hopes that a hunter can recover his or hers arrowhead if by chance it ended Up embedded into a log or a tree.

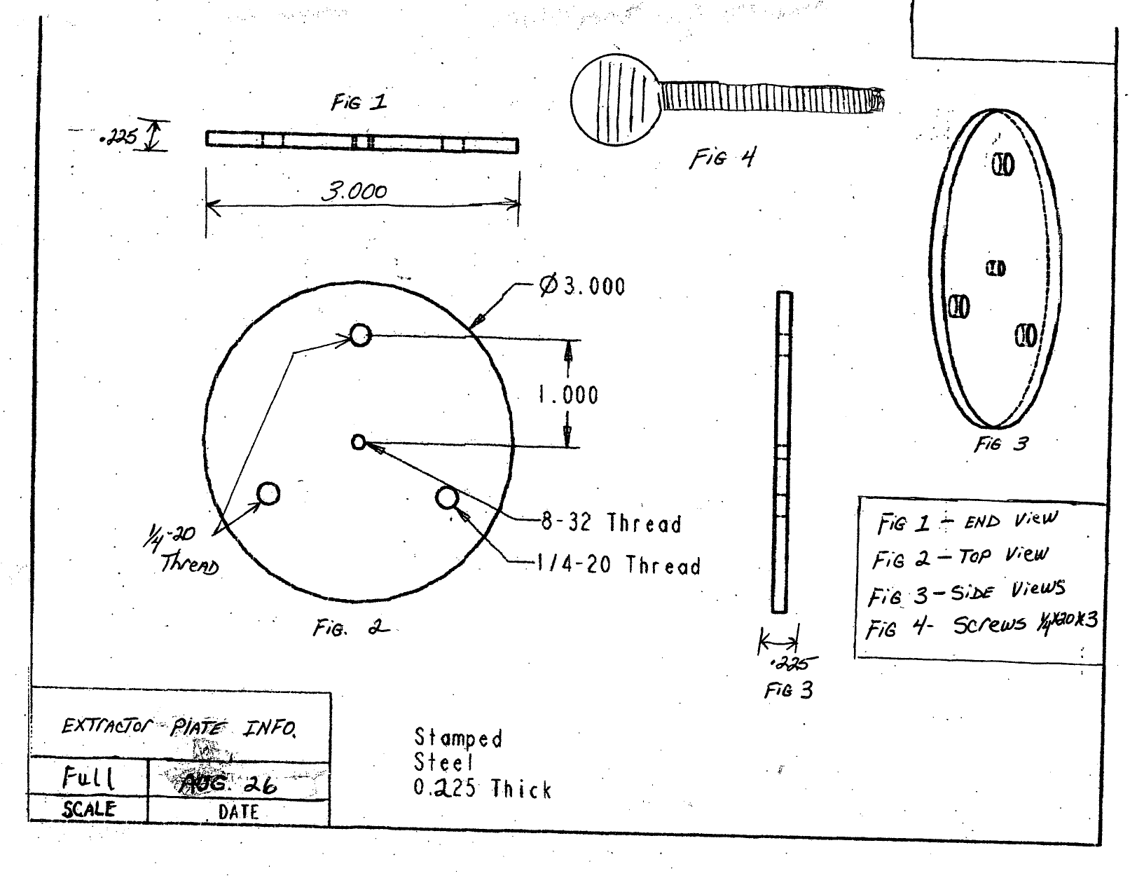

The Arrowhead extractor easily removes arrowheads.

Once an arrowhead becomes Embedded into a foreign substance, such as a tree, simply attach the extractor plate To the arrowhead, and then thread the removing screws into the extractor plate and Begin tightening down against the foreign object until arrowhead is extracted.

1. I claim the Arrowhead extractor as my sole invention And in the process of getting a full utility patent on it
